(19) United States
(12) Patent Application Publication
(10) Pub. No.: US 2017/0249446 A1
(43) Pub. Date: Aug. 31, 2017

(54) VIRTUAL JUMP ROPE

(71) Applicant: Kenneth A. Wright, Santee, CA (US)

(72) Inventor: Kenneth A. Wright, Santee, CA (US)

(73) Assignee: FORECEFIELD TECHNOLOGIES, LLC, VALLEY CENTER, CA (US)

(21) Appl. No.: 15/503,712

(22) PCT Filed: Aug. 17, 2015
(86) PCT No.: PCT/US15/45565

§ 371 Date: Feb. 14, 2017

Related U.S. Application Data
(60) Provisional application No. 62/038,101, filed on Aug. 15, 2014.

(51) Int. Cl. G06F 19/00; A63B 22/00; A63B 21/06; A63B 71/06; A63B 21/22; A63B 23/035; A63B 23/12; A63B 5/20; A63B 21/005

(52) U.S. Cl. CPC G06F 19/3481; A63B 5/205; A63B 22/0012; A63B 21/0602; A63B 21/06; A63B 21/005; A63B 21/222; A63B 23/03541; A63B 23/1209; A63B 71/0622; A63B 2207/02; A63B 2220/17; A63B 2071/0625; A63B 2230/75; A63B 2071/0655; A63B 2210/50; A63B 2225/09; A63B 2225/20; A63B 2225/50

(57) ABSTRACT

Implementations described and claimed herein provide systems, apparatuses, and methods for providing cardiovascular exercise by simulating an exercise experience, such as a jump rope experience. In one implementation, a pair of exercise simulators is provided. Each of the exercise simulators includes a spin assembly rotationally mounted to a handle along an axis line. The spin assembly is configured to rotate about the axis line. At least one weight is housed in the spin assembly, and a light source is configured to rotate about the axis line with the spin assembly. The light source is configured to emit light to provide a visual representation of the motion of the spin assembly.

### CROSS-REFERENCE TO RELATED APPLICATIONS

The present application claims priority under 35 U.S.C. §119 to U.S. Provisional Patent Application No. 62/038,101, entitled “Virtual Jump Rope” and filed on Aug. 15, 2014, which is hereby incorporated by reference in its entirety into the present application.

### TECHNICAL FIELD

Aspects of the present disclosure relate to exercise systems, apparatuses, and methods and more particularly to systems, apparatuses, and methods for providing cardiovascular exercise by simulating a jump rope experience.

### BACKGROUND

Cardiovascular exercise promotes health by providing many physiological benefits, including weight control, increased energy, improved mood, disease prevention, increased physical fitness, and the like. Despite the benefits of cardiovascular exercise, many people struggle to consistently reserve time for cardiovascular exercise in their busy schedules. Jumping rope consistently remains an effective form of cardiovascular exercise that is easy to fit into busy schedules. A jump rope is compact and portable, and quickly burns calories, while improving muscle tone. However, conventional jump ropes generally require a relatively large space for an individual to exercise without any interference by surfaces or items with the rope. For example, many conventional jump ropes require a four-foot by six-foot space with a clearance of approximately 10 inches of space above the individual's head. Consistently finding such a space, particular indoors, is often challenging and may deter people from regular exercise.

It is with these observations in mind, among others, that various aspects of the present disclosure were conceived and developed.

### SUMMARY

Implementations described and claimed herein address the foregoing problems, among others, by providing systems, apparatuses, and methods for providing cardiovascular exercise by simulating an exercise experience, such as a jump rope experience. In one implementation, a pair of exercise simulators is provided. Each of the exercise simulators includes a spin assembly rotationally mounted to a handle along an axis line. The spin assembly is configured to rotate about the axis line. At least one weight is housed in the spin assembly, and a light source is configured to rotate about the axis line with the spin assembly. The light source is configured to emit light to provide a visual representation of the motion of the spin assembly.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows a user exercising with an example virtual jump rope, a direction of light emitted by a pair of light sources and a path of the emitted light as the user exercises are shown in broken lines.

FIGS. 2A and 2B show a side view and a proximal view, respectively of an example exercise simulator.

FIG. 3 illustrates a cross sectional view of an example exercise simulator.

FIG. 4 shows a perspective view of an example exercise simulator.

FIG. 5 shows the exercise simulator of FIG. 4 with a housing door removed to show a spin assembly.

FIG. 6 shows the exercise simulator of FIG. 5 with a housing cover removed.

FIG. 7 shows the exercise simulator of FIG. 6 illustrating movement of the spin assembly.

FIGS. 8A and 8B illustrate proximal and distal perspective views, respectively, of an example exercise simulator with a straight handle.

FIGS. 9A and 9B illustrate proximal and distal perspective views, respectively, of an example exercise simulator with an angled handle.

FIGS. 10A and 10B show side views of the exercise simulator of FIGS. 8A-B and 9A-B, respectively.

FIG. 11 shows a proximal view of the exercise simulator of FIGS. 8A and 8B.

FIG. 12 illustrates a cross sectional view of the exercise simulator taken along the line shown in FIG. 11.

FIG. 13 shows an example spin assembly of the exercise simulator of FIG. 11.

FIG. 14 shows a proximal view of the exercise simulator of FIGS. 9A and 9B.

FIG. 15 illustrates a cross sectional view of the exercise simulator taken along the line shown in FIG. 14.

FIG. 16 shows an exploded view of an example exercise simulator.

FIG. 17 is an exploded view of an example spin assembly.

FIG. 18 is an example exercise system, including a health manager running on a computer server, computing device, or other device coupled with a network, for providing cardiovascular exercise, including the simulation of a jump rope experience.

FIG. 19 is an example graphical user interface generated by the health manager and displayed with a user device

FIG. 20 is an example of a computing system that may implement various systems and methods discussed herein.

### DETAILED DESCRIPTION

Aspects of the present disclosure involve systems, apparatuses, and methods for providing cardiovascular exercise by simulating a jump rope experience. In one aspect, a virtual jump rope is provided that mimics the feel and sound of a conventional jump rope (i.e., a rope connected at each end to a handle) using a counterweight mounted to a bearing and shaft. A light-emitting diode (LED) or other light source spins in conjunction with the counterweight to illustrate motion and to add visual motivation, cues, and/or other aesthetics to the jump rope experience. Other electronics, sensors, operations, and/or displays may be integrated into the virtual jump rope, for example, to provide a jump counter, resistance or other force, calories burned, watts, and/or the like. Power may be provided to the virtual jump rope using one or more power sources, including, without limitation, battery, motion/spin generator, and/or the like. Additionally, other elements may be added to induce force or resistance, such as electromechanical or gyroscopic forces. The virtual jump rope includes a pair of handles extending from a housing containing the LED and counterweight. Each of the handles may have a gimbal, ball joint, set points, and/or the like for adjusting the handle relative to the housing facilitating ergonomics and efficacy.

The various systems and methods disclosed herein generally provide for the simulation of a traditional exercise experience using a virtual apparatus. The example implementations discussed herein reference simulating a jump rope experience using a pair of exercise simulators. However, it will be appreciated by those skilled in the art that the presently disclosed technology is applicable to other forms of cardiovascular and non-cardiovascular exercise, as well as other products or devices for simulating movement.

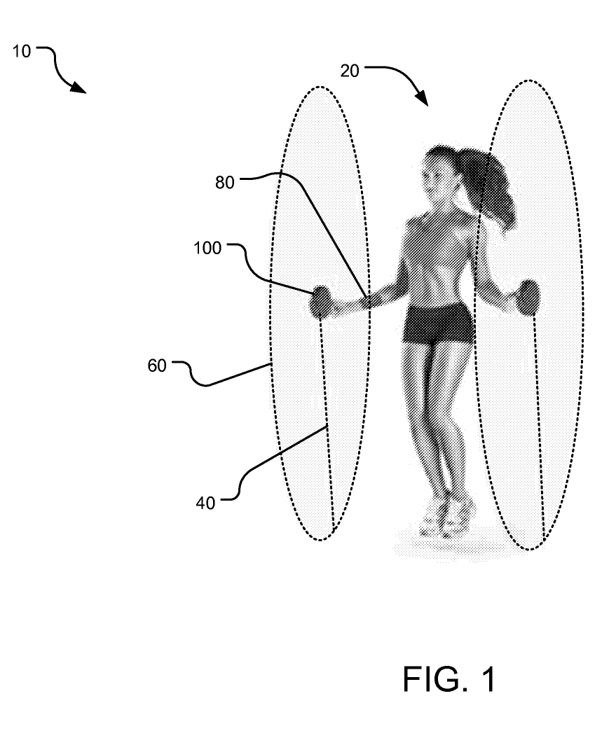

For a detailed description of a user 20 exercising with an example virtual jump rope 10, reference is made to FIG. 1. As shown in FIG. 1, in one implementation, a virtual jump rope 10 includes a pair of exercise simulators 100 configured to mimic a conventional jump rope, which generally includes an elongated rope of material connected at each end to a handle.

The user 20 may engage in a jump rope circuit or other jump rope exercise or entertainment by gripping the exercise simulator 100 in each hand and performing the motion traditionally associated with a conventional jump rope. In particular, the user 20 rotates her hands to move the exercise simulator 100 and jumps at regular intervals based on the rotational movement. When a conventional jump rope is utilized, the user 20 jumps each time the rope reaches the surface on which the user 20 is exercising to jump over the rope. The virtual jump rope 10 simulates this action using one or more weights and one or more light sources.

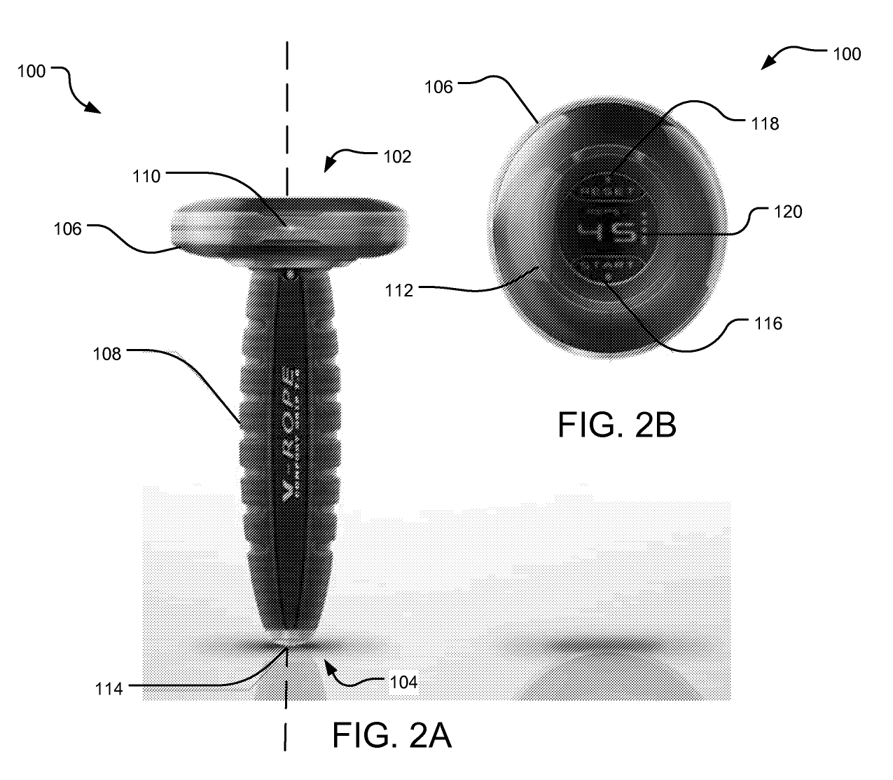

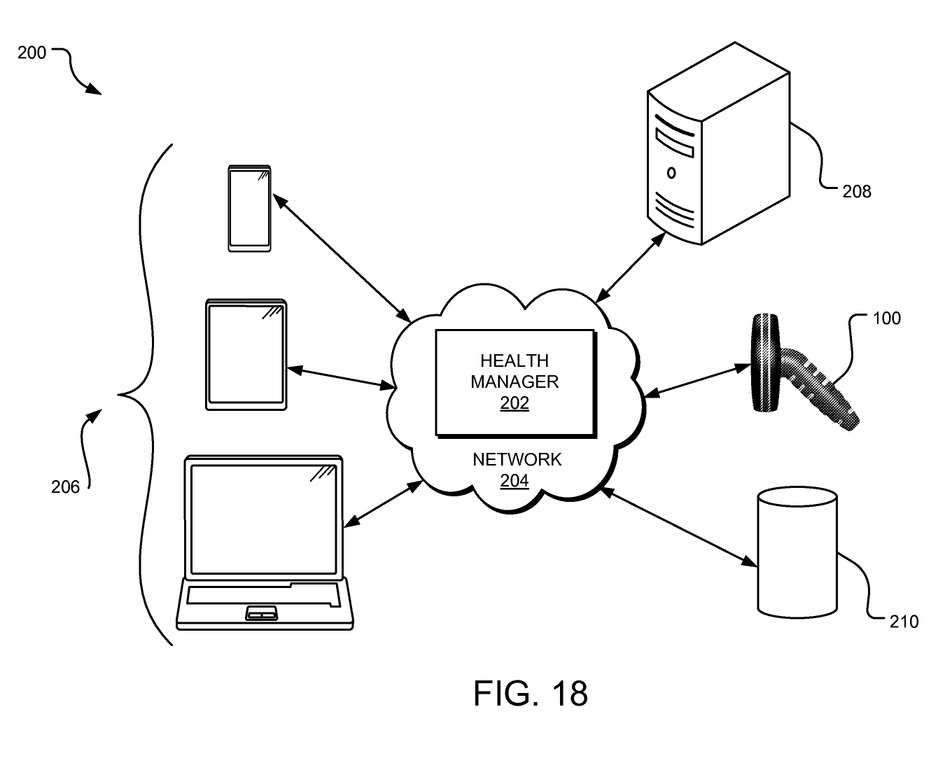

In one implementation, each of the exercise simulators 100 of the virtual jump rope 10 includes one or more weights rotationally mounted to a handle to mimic the feel of a jump rope experience. Further, as can be understood from FIG. 1, each of the exercise simulators 100 includes a light source, such as an LED, that spins during the motion of the exercise simulator 100 to provide a visual indication to the user 20 of when to jump. Similarly, the exercise simulators 100 may include one or more speakers to mimic the sound of a rope striking a surface during traditional jumping rope to further enhance the aesthetics and provide a realistic experience. A path 40 of light emitted by light sources in the exercise simulators 100 of the virtual jump rope 10 and an exercise path 60 of the emitted light as the user 20 exercises are illustrated broken lines in FIG. 1. In one implementation, a user interface 80 provides feedback to the user 20 regarding the exercise and control over operation of the exercise simulators 100. The user interface 80 may be provided via a user device, described, for example, with respect to FIGS. 18-20, or via the exercise simulator 100 directly, described for example, with respect to FIGS. 2A-2B.

Turning to FIGS. 2A-B, in one implementation, the exercise simulator 100 includes a housing 106 disposed at a proximal end, a handle 108 extending from the housing 106 to a distal end 104, and a power button 114, which may be disposed anywhere on the exercise simulator 100, for example, at the distal end 104 of the handle 108.

In one implementation, the housing 106 includes a rope simulator 110, which emits visible light in along the path 40 to simulate a position of a rope as the rope simulator 110 rotes about an axis of the exercise simulator 100, shown as broken lines in FIG. 2A. Stated differently, the rope simulator 110 emits light in a single direction (i.e., along the path 40), which creates the exercise path 60 as the rope simulator 110 rotates about the axis line during movement by the user 20.

The exercise simulator 100 may include various features to optimize the user experience. For example, the handle 108 may include a soft grip material for comfort during use. The handle 108 may be straight, angled, and/or adjustable relative to the housing 106 for ergonomics and efficacy.

Additionally, the exercise simulator 100 may include the user interface 80 to provide feedback and operational control. In one implementation, the housing 106 may include the user interface 80 displaying feedback to the user 20 through a transparent window 112 and having one or more options. For example, the user interface 80 may include a reset button 118 and a start/stop button 116 for controlling an exercise session. The feedback 120 displayed to the user 20 via the user interface 80 may include various information about the exercise session, including without limitation, repetitions, calories burned, watts, and/or the like. There may be additional options such as modifying force or resistance, selecting a user, programming a user, and/or the like.

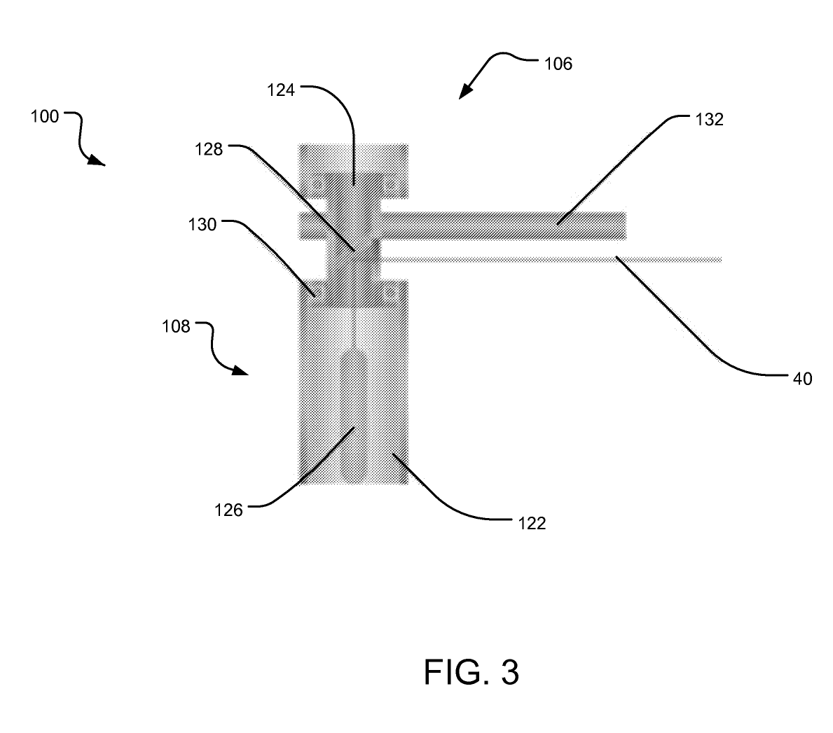

As can be understood from FIG. 3, in one implementation, the exercise simulator 100 includes an inner shaft 124 rotationally mounting one or more weights 132 to an outer shaft 122 using one or more bearings 130. The outer shaft 122 may extend through a lumen in the handle 108 or form the handle 108. The bearings 130 may be one-way locking needle-roller bearings that prevent the weights 132 from rotating against a direction of motion during use.

In one implementation, the rope simulator 110 includes one or more light sources 126 is mounted within a lumen of the outer shaft 122 and configured to emit light through a light pipe to simulate a rope along the path 40. To generate light along the path 40, in one implementation, the light source 126 emit light in a direction towards the inner shaft 124, which is redirected using one or more mirrors 128 along the path 40 in a direction generally transverse to the inner shaft 124 and parallel to the one or more weights 132. Stated differently, the mirror 128 is mounted in a lumen of the inner shaft 124 at an angle relative to the light source 126, such that the light is reflected along the path 40. As such, the emitted light matches the movement of the one or more weights 132 as they rotate about an axis line extending generally through an approximate center of the inner shaft 132.

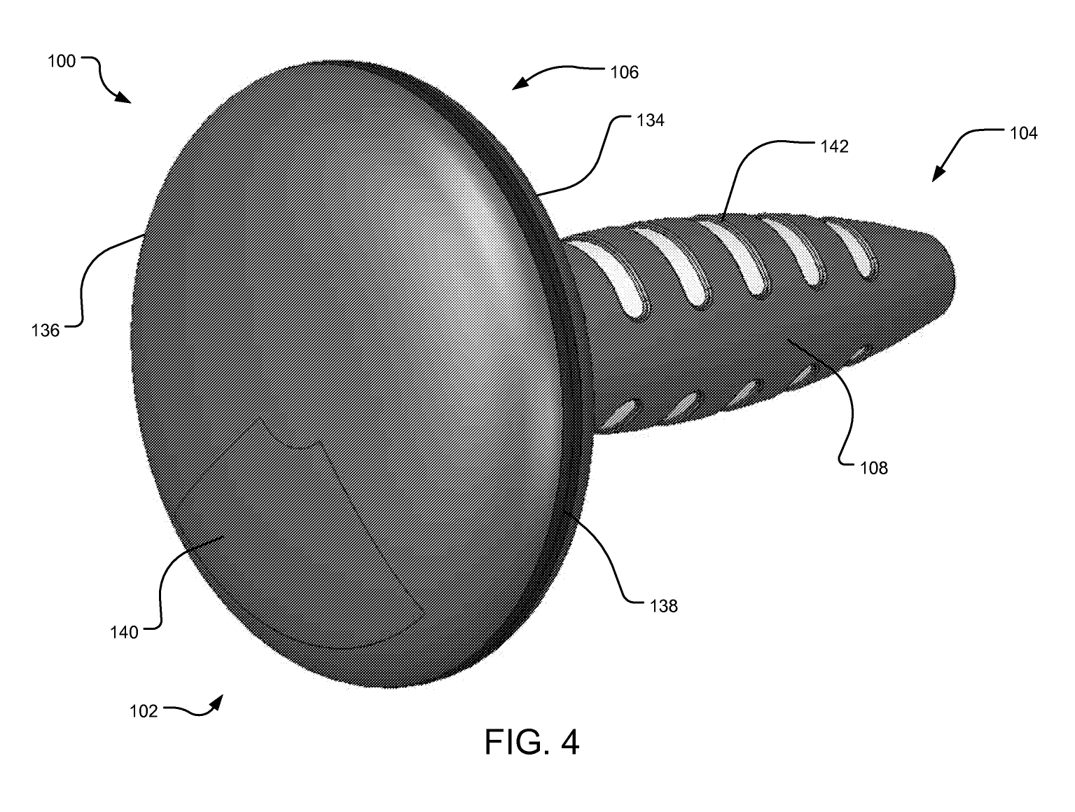

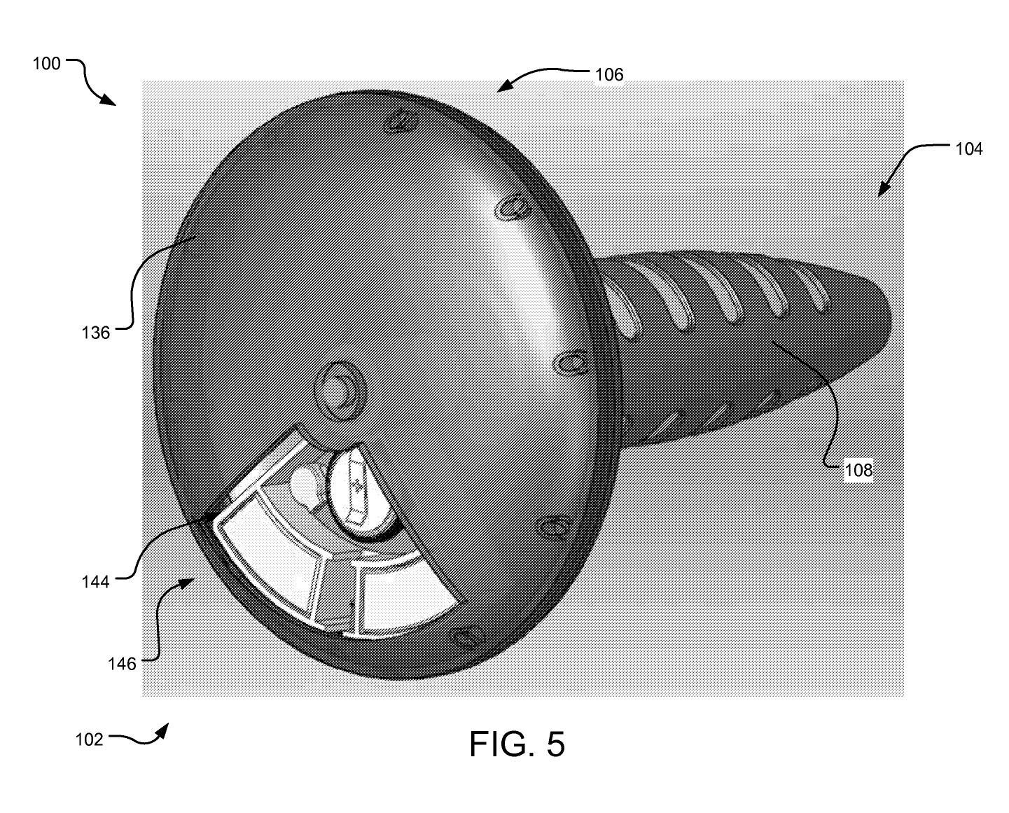

For a detailed description of the movement of the exercise simulator 100 during use, reference is made to FIGS. 4-7. In one implementation, the handle 108 is sized and shaped for comfortable gripping by a hand of the user 20 to facilitate movement during simulated jump rope exercise. For example, a surface 142 of the handle 108 may include a soft material, textures, grips, and/or other features to enhance gripping and comfort during use.

To protect the internal components during use, the housing 106 may include a proximal cover 136 and the distal cover 134. The proximal cover 136 may be transparent to display the internal components, opaque, or include various aesthetic features. The proximal cover 136 may include the user interface 80 to provide feedback 120 and/or user controls, as described herein. In some implementations, the exercise simulator 100 does not include the proximal cover 136. In other implementations, the proximal cover 136 includes a removable door 140 to facilitate access to the inner components of the housing 106 through an opening 144 without removing the proximal cover 134. For example, the door 140 may be removed to access a spin assembly 146 for maintenance.

In one implementation, the housing 106 contains the light source 126 configured to emit light through a light pipe 138 as the light source 126 rotates about an axis line during movement. The light pipe 138 is mounted to the distal cover 134 and configured to permit the transmission of light from the light source 126 therethrough. In one implementation, the proximal cover 136 is configured to attach to the distal cover 134, such that the light pipe 138 is disposed between the covers 134 and 136.

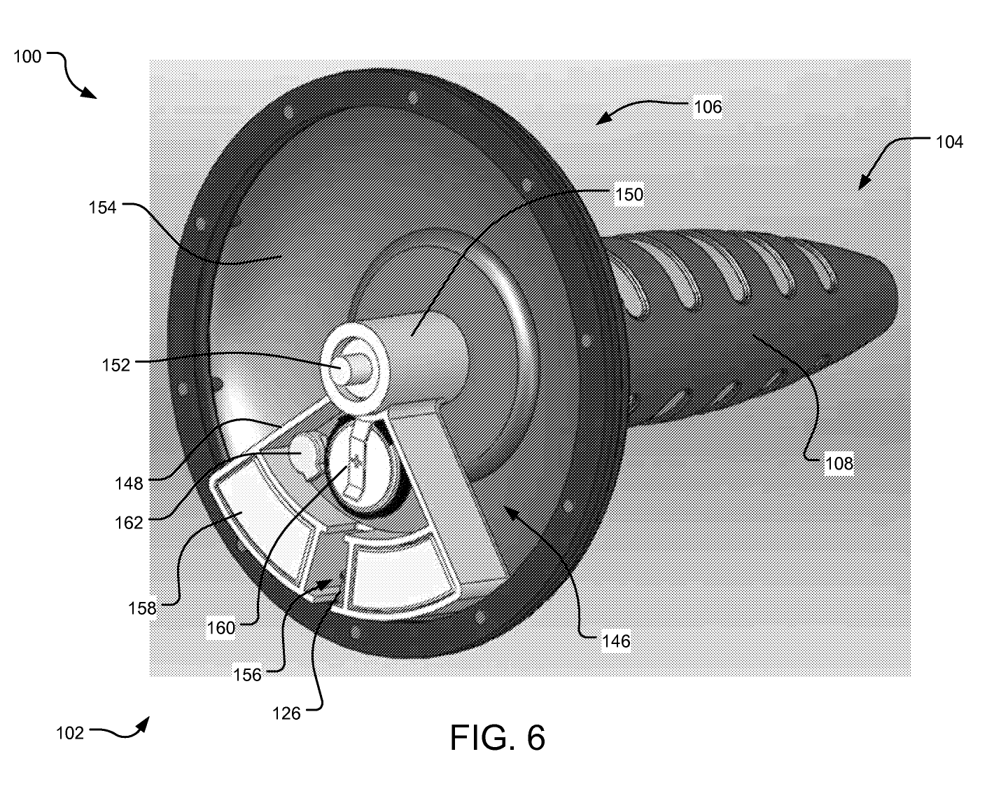

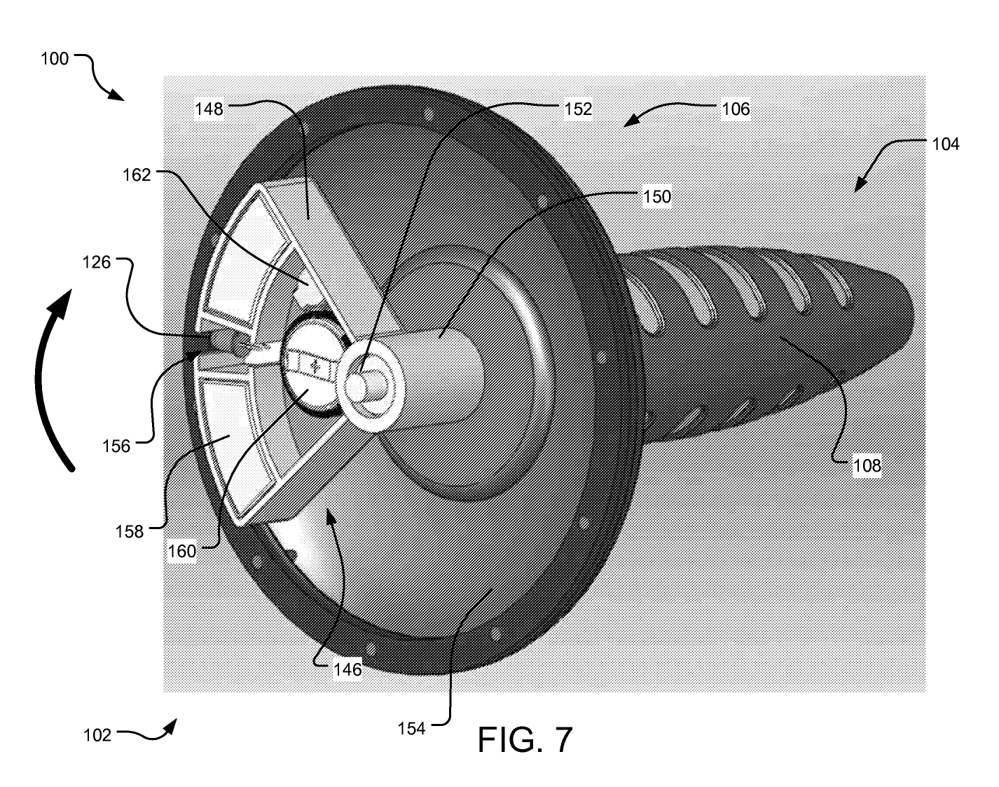

To create a stable rotational axis line, in one implementation, the handle 108 is mounted to the housing 106 using a shaft 152 (e.g., the inner shaft 124) extending from an opening in the handle 108 through an opening in the distal cover 136. The bearings 130 may be used to rotationally mount the spin assembly 146 on the shaft 152. Stated differently, in one implementation, the shaft 152 extends from the handle 108 through the distal cover 136 into a receiver 150 in the spin assembly 146, and the spin assembly 146 is positioned and secured using the bearings 130. In one implementation, the spin assembly 146 is configured to move about the axis line defined by the shaft 152 along a surface 154 of the distal cover 136 to create an arced path following to the light pipe 138, as illustrated in FIGS. 6 and 7.

To simulate the jump rope experience during movement by the user 20, in one implementation, the spin assembly 146 includes a base 148 with one or more compartments for holding internal components of the exercise simulator 100, which rotate with the spin assembly 146 during movement. For example, the compartments may be sized and shaped to hold one or more weights 158, a speaker 162, one or more batteries 160, and the light source 126. It will be appreciated that one or more of these components may alternatively be disposed within a lumen of the handle 108.

In one implementation, the light source 126 is positioned within a compartment having a light transmitter 156 (e.g., an opening, channel, or light transmittable material) configured to permit light to be emitted outside the housing 106 through the light pipe 138. The weights 158 may be positioned to provide a realistic exercise experience and to facilitate the rotational movement of the spin assembly 146. In one implementation, the weights 158 are made from a solid material in the form of weighted plates, bars, disks, or the like. In another implementation, the weights 158 are hydro or other fluid providing counterweight. In some implementations, the weights 158 may be removed and replaced to provide various levels of resistance.

The weight and rotational movement of the spin assembly 146 provides a realistic feel to the jump rope experience. Further, the spin assembly 146 rotates about the axis line as the user 20 turns the exercise simulator 100, thereby creating the exercise path 60 with the light source 126 to simulate visual movement of a rope and otherwise simulating the jump rope experience. The exercise simulator 100 may provide additional visual, tactile, and/or audial simulations to enhance the experience.

For example, the speaker 162 is configured to generate a variety of sounds. For example, a whoosh sound, a click sound, a swoosh, and other simulated or synthesized sounds to provide motivation, cues, and/or otherwise enhance the exercise experience and make it more realistic. Furthermore, the exercise simulator 100 may provide haptic feedback, for example, vibrations through the handle 108 or speaker 162, clicks, thumps, and/or the like to further provide motivation, activity cues, and to otherwise enhance the simulated experience.

Furthermore, in addition to a visual digital readout, which may be displayed with the user interface 80, the speaker 162 may provide audio feedback for a particular workout, as well as provide motivational or other verbal feedback. In one implementation, the exercise simulator includes microcurrent stimulation or other feedback to stimulate muscles and promote weight loss. In some implementations, such audial, visual, and haptic feedback, are provided via a user device, as detailed with respect to FIGS. 18-20.

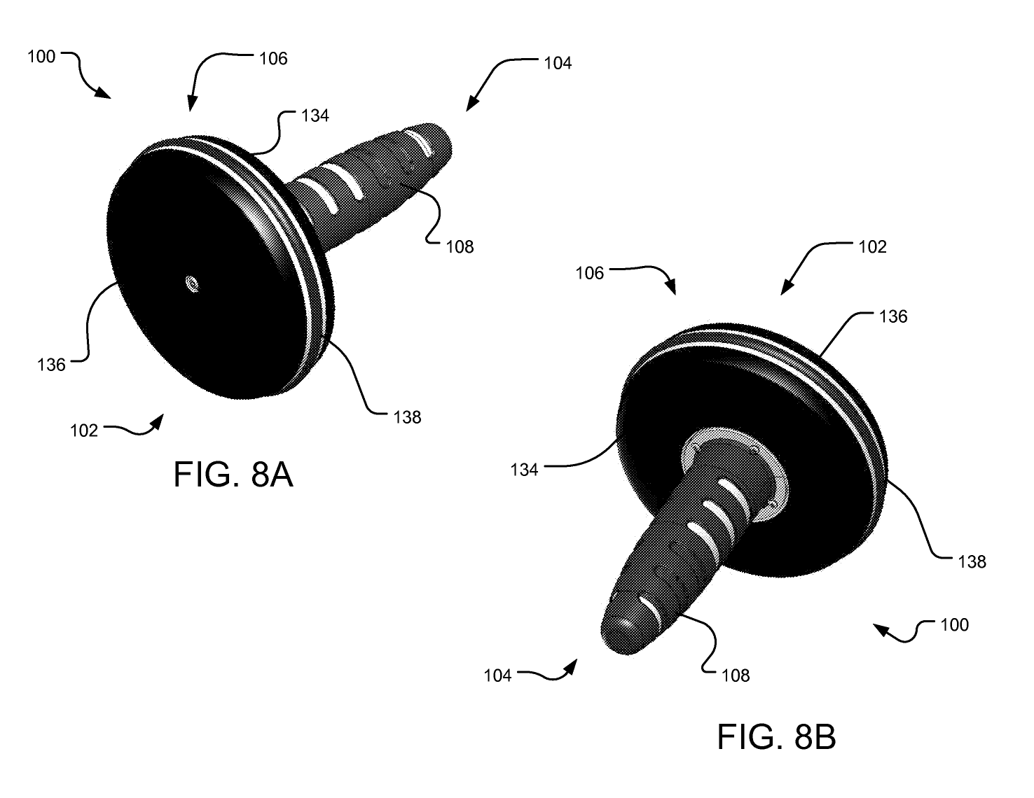

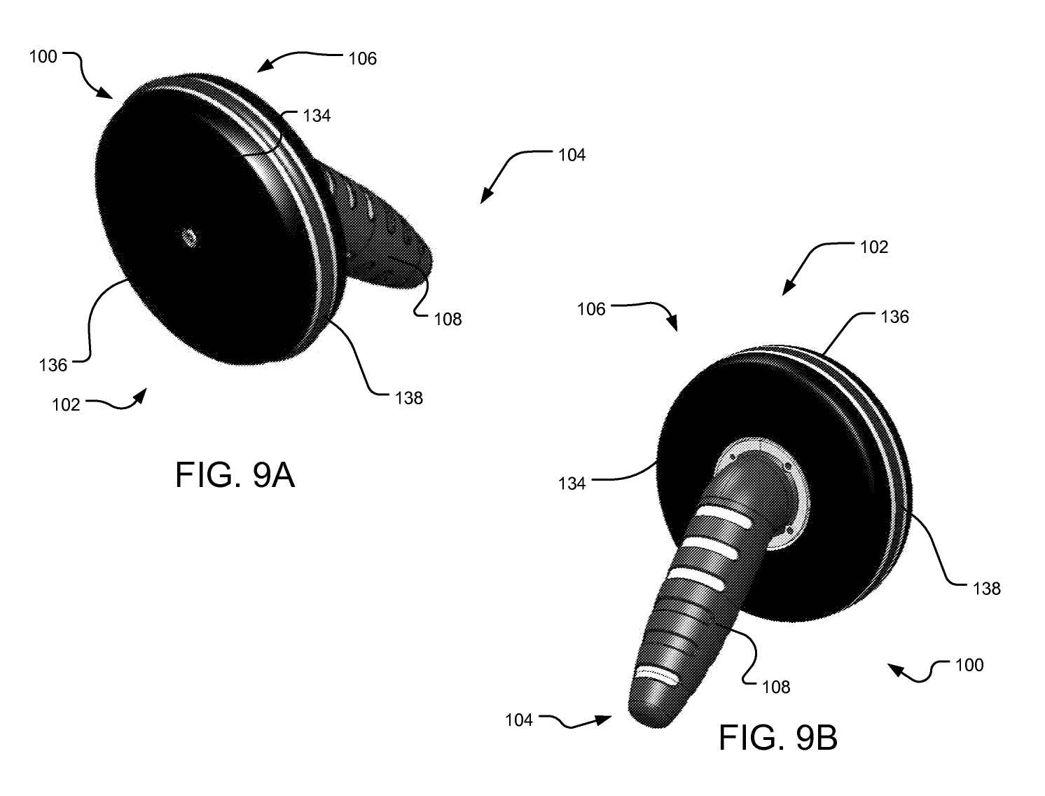

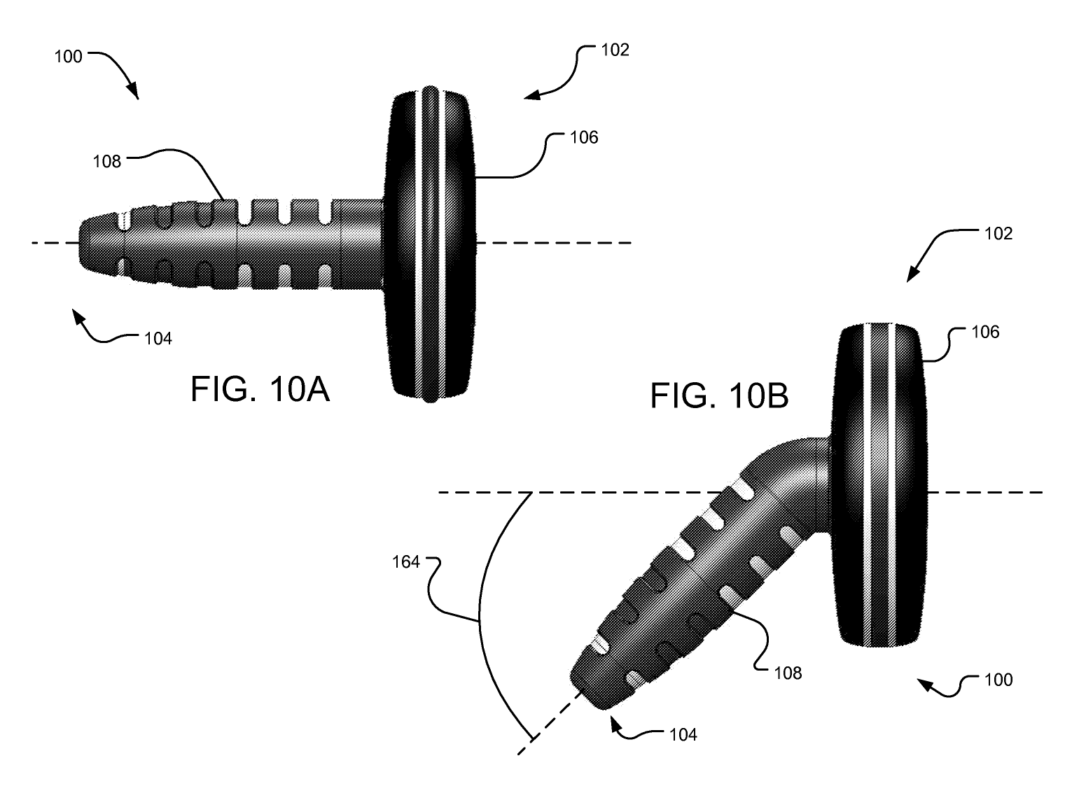

As can be understood from FIGS. 8A-10B, the handle 108 is mounted to the housing 106, such that the handle 108 extends from an approximate center of a distal cover 134 of the housing 106. The center may be disposed on an axis line of the exercise simulator 100. The handle 108 may extend linearly along the axis line, at an angle 164 (e.g., 45 degrees) relative to the axis line, along a contour, and/or the like for ergonomics. The handle 108 may additionally be adjustable to customize the exercise simulator 100 to the user 20. For example, the handle 108 may include a gimbal, a ball joint, set points, and/or the like facilitating adjustment of the handle 108 relative to the housing 106.

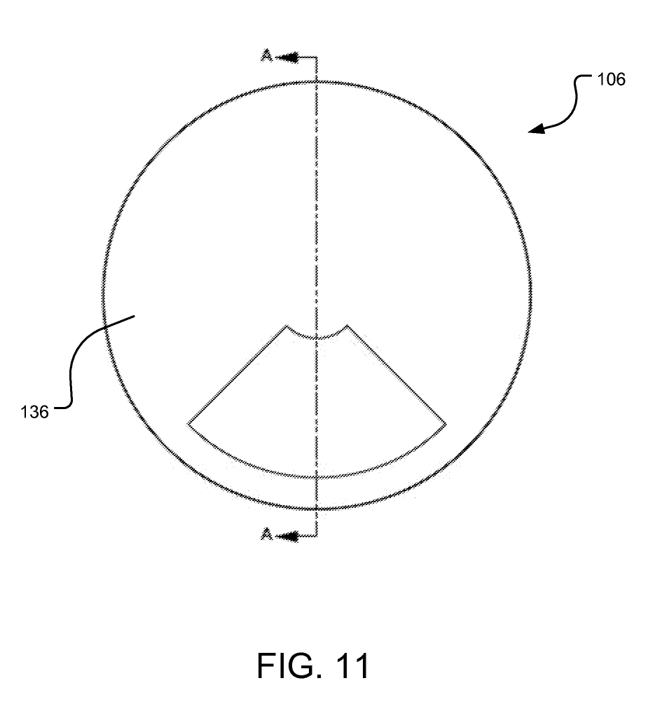

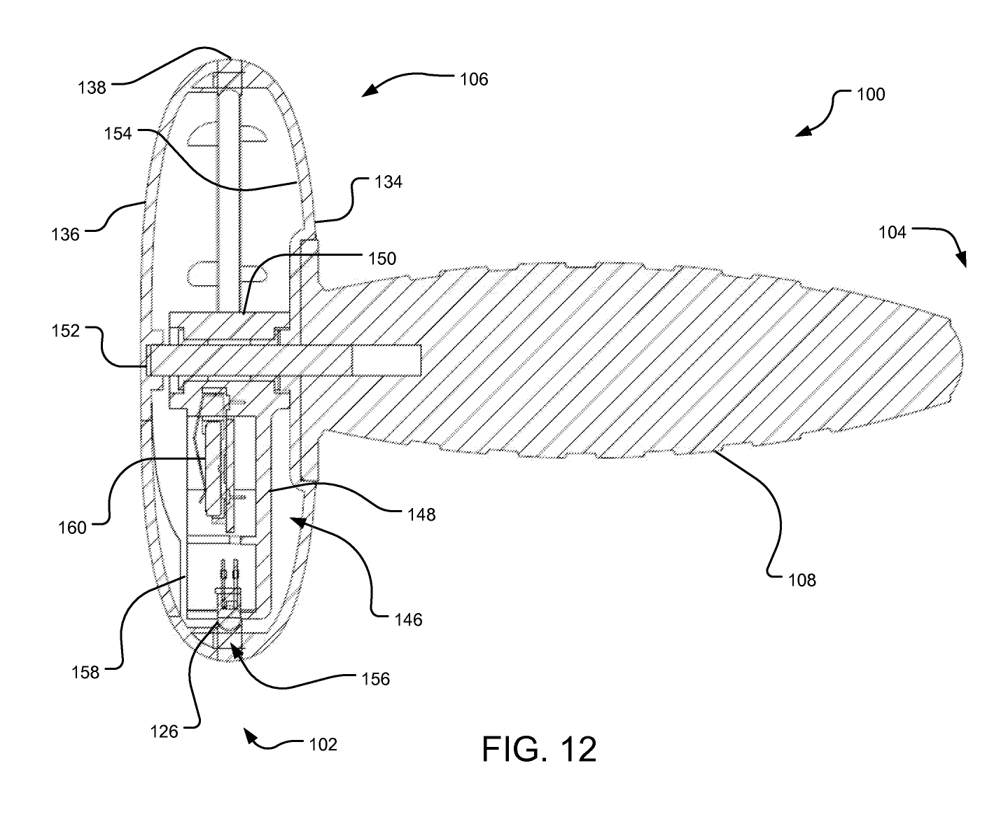

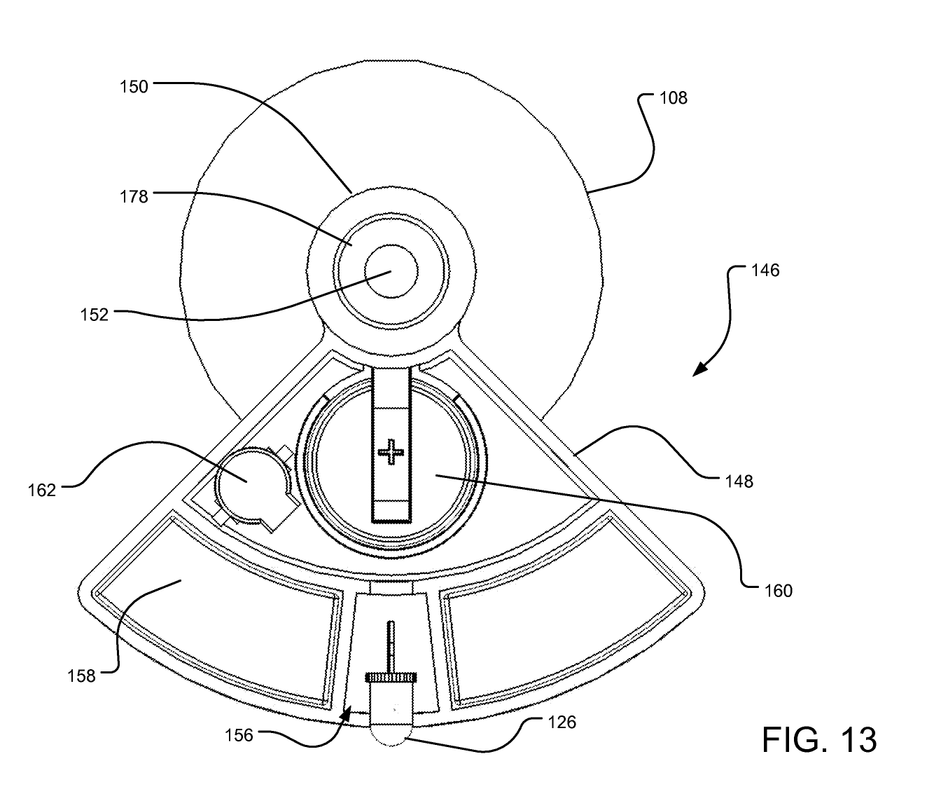

Turning to FIGS. 11-13, in one implementation, the shaft 152 extends along and defines a rotational axis line of the exercise simulator 100, disposed at a center of the housing 106 and the handle 108. The spin assembly 146 is rotationally mounted to the shaft 152 and houses the weights 158, the light source 126, the batteries 160, and the speaker 162.

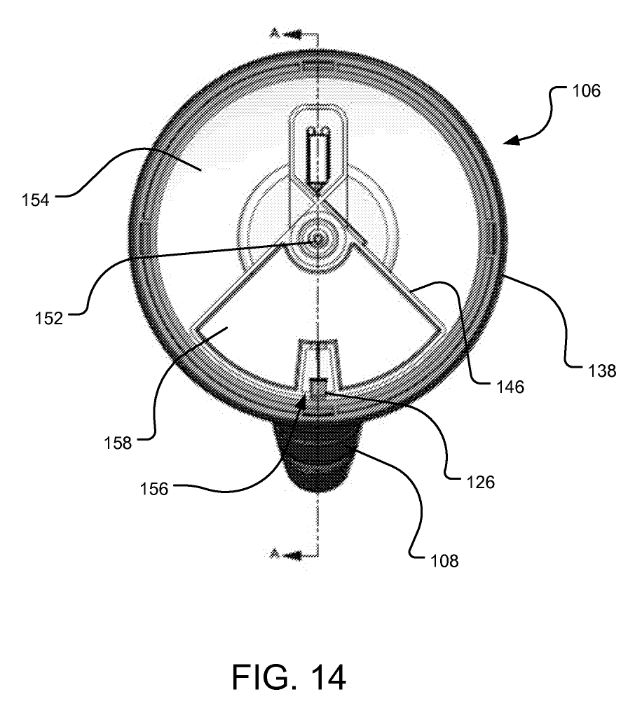

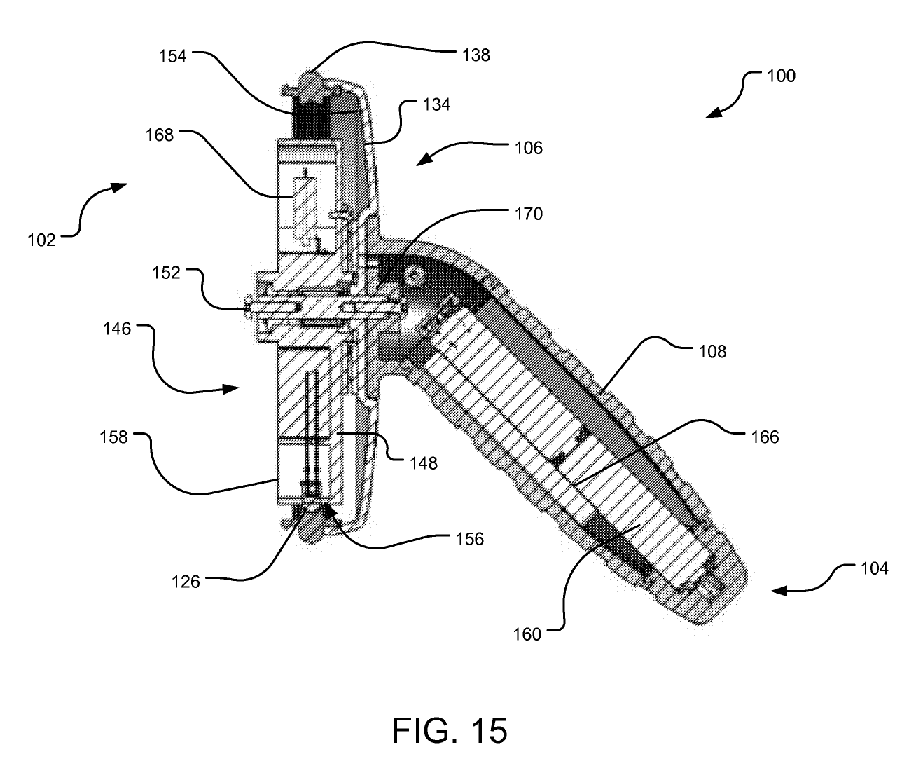

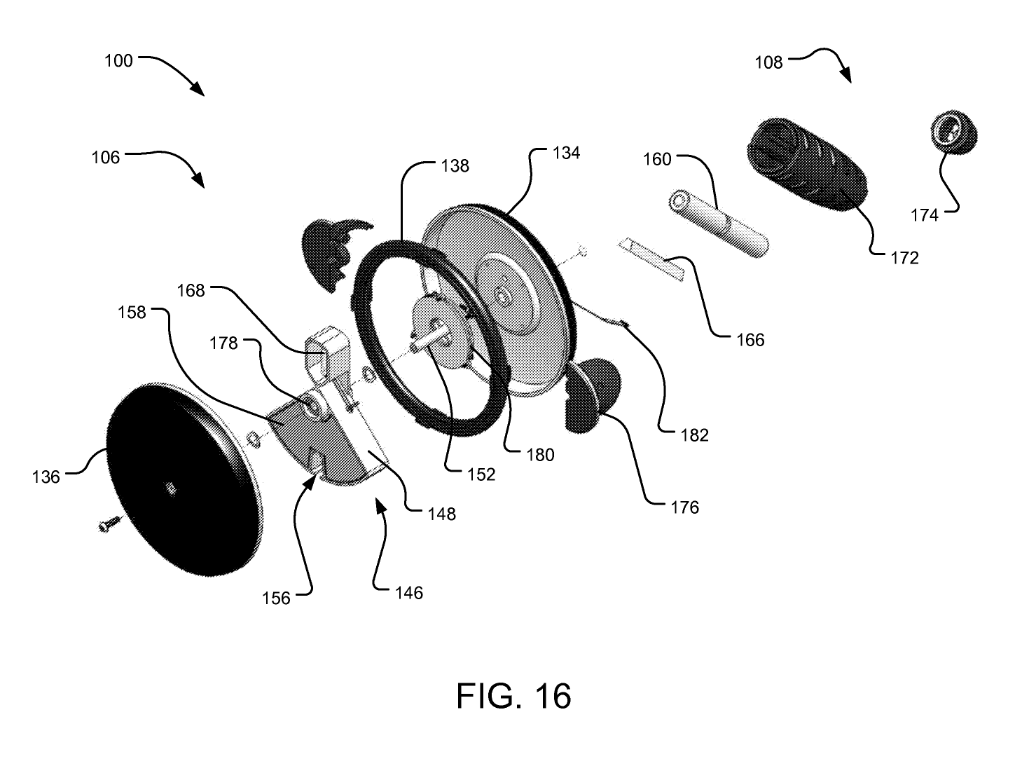

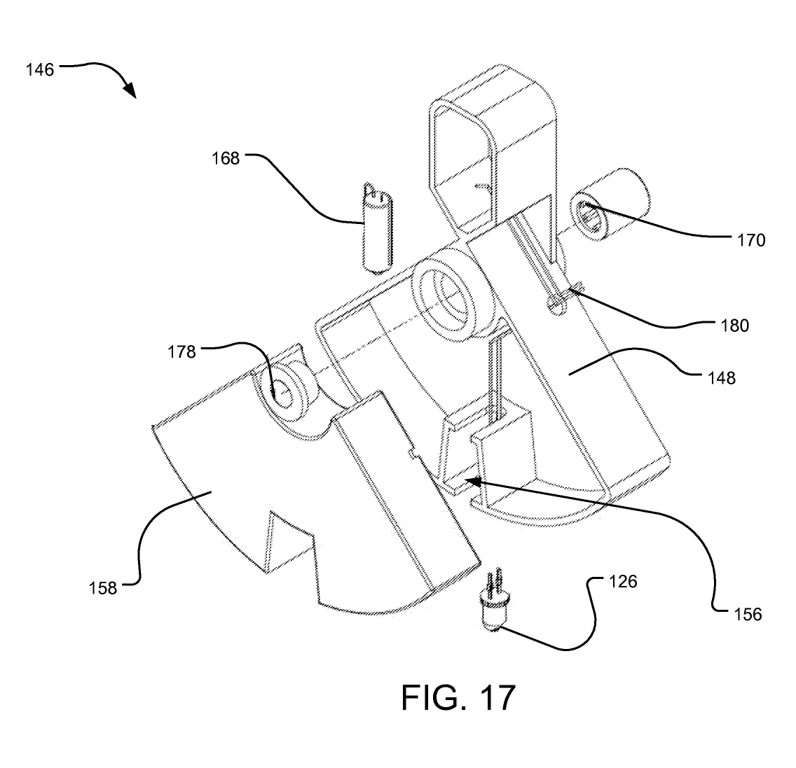

Referring to FIGS. 14-17, in another implementation, the shaft 152 extends along and defines a rotational axis line of the exercise simulator 100, disposed at a center of the housing 106 and at an angle relative to the handle 108. In one implementation, the batteries 160 are housed in a lumen of the handle 108 along with a handle contact holder 166. The handle 108 may include a handle cover 172 mounted to the distal cover 134 of the housing 106 and a distal cap 174. In one implementation, the distal cap 174 includes a first battery contact and a second battery contact 182 is disposed at a proximal end of the handle 108 to place the batteries 160 in electrical communication with a controller 180 having a contact ring and Printed Circuit Board (PCB) for controlling the operations of the exercise simulator 100. The handle 108 may be mounted to the housing 106 using one or more handle mounts 176.

In one implementation, the spin assembly 146 is rotationally mounted to the shaft 152 and houses the weights 158 and the light source 126. The spin assembly 146 may further house a switch 168 in electrical communication with the light source 126 via one or more wires 180 to control operation of the light source 126 in response to input via the user interface 80. In one implementation, the spin assembly 146 is rotationally mounted using a sleeve bearing 178 and one or more one-way locking needle-roller bearings 170 that prevent the weights 158 from rotating against a direction of motion during use.

FIG. 18 is an example exercise system 200, including a health manager 202 running on a computer server, computing device, or other device coupled with a network 204, for simulating an exercise experience, such as jump rope, to provide cardiovascular exercise and monitor health. The network 204 is used by one or more computing or data storage devices (e.g., one or more user devices 206, a server 208, one or more databases 210, etc.) for implementing the exercise system 200. The user device 206 is generally any form of computing device capable of interacting with the network 204, such as a personal computer, workstation, terminal, portable computer, mobile device, smartphone, tablet, multimedia console, and/or the like.

In one implementation, the user 20 accesses and interacts with the health manager 202 via the network 204 (e.g., the Internet) with the user device 206 communicatively connected to the network 204. In another implementation, the user device 206 locally runs the health manager 202, and the exercise simulator 100 connects to the user device 206 using a wired connection (e.g., the Universal Serial Bus connection) or wireless connection (e.g., Bluetooth connection). In some implementations, the user 20 accesses and interacts with the health manager 202 on the user device 206 via the network 204, and the exercise simulator 100 communicates with the user device 206 via wired or wireless connection.

The server 208 may host the exercise system 200. The server 208 may also host a website or an application, such as the health manager 202 that users visit to access the system 200. The server 208 may be one single server, a plurality of servers with each such server being a physical server or a virtual machine, or a collection of both physical servers and virtual machines. In another implementation, a cloud hosts one or more components of the exercise system 200. One or more exercise simulators 100, the user devices 206, the server 208, and other resources, such as the databases 210, connected to the network 204 may access one or more other servers for access to one or more websites, applications, web services interfaces, etc. that are used for exercise simulation and health management. The server 208 may also host a search engine that the system 200 uses for accessing and modifying information used for exercise simulation, health monitoring, and/or the like.

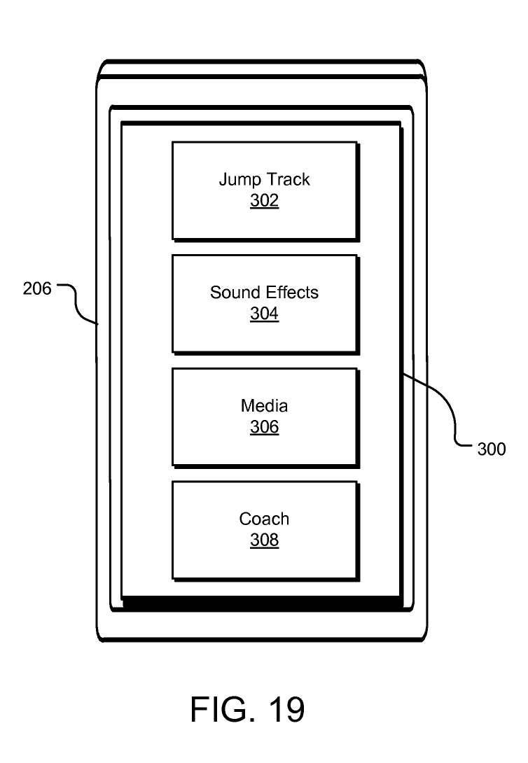

In one implementation, the health manager 202 generates the user interface 80 for display on the user device 206 and controls the operation of the exercise simulator 100. For example, as can be understood from FIG. 19, in one implementation, the user interface 80 includes a graphical user interface 300 displayed on the user device 206 with various options for controlling the exercise simulators 100 and managing the exercise experience. The options include a jump track 302 displaying a number of jumps, a calorie count, and/or other information regarding a current workout or comparing to other workouts; a sound effects option 304 to select sounds for a jump (e.g., swoosh, click, or other simulated or synthesized sounds) or to select other forms of feedback, such as visual or haptic; a media option 306 to present videos, articles, and/or other content regarding exercise, health, instructions for use, and/or the like; and a coach option 308 to customize a workout coach for the exercise. It will be appreciated that the graphical user interface 300 is exemplary only and other information and controls may be provided.

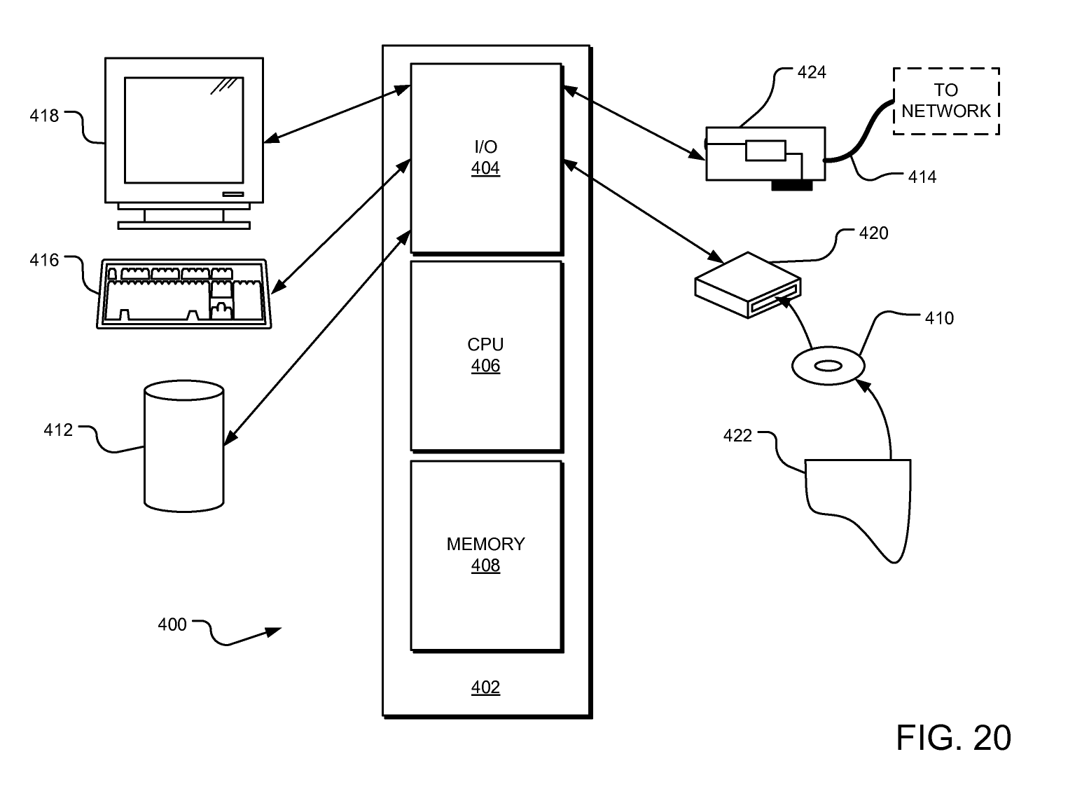

Referring to FIG. 20, a detailed description of an example computing system 400 having one or more computing units that may implement various systems and methods discussed herein is provided. The computing system 400 may be applicable to the user devices 206, the servers 208, components of the exercise simulators 100, or other computing devices. It will be appreciated that specific implementations of these devices may be of differing possible specific computing architectures not all of which are specifically discussed herein but will be understood by those of ordinary skill in the art.

The computer system 400 may be a general computing system is capable of executing a computer program product to execute a computer process. Data and program files may be input to the computer system 400, which reads the files and executes the programs therein. Some of the elements of a general purpose computer system 400 are shown in FIG. 20 wherein a processor 402 is shown having an input/output (I/O) section 404, a Central Processing Unit (CPU) 406, and a memory section 408. There may be one or more processors 402, such that the processor 402 of the computer system 400 comprises a single central-processing unit 406, or a plurality of processing units, commonly referred to as a parallel processing environment. The computer system 400 may be a conventional computer, a distributed computer, or any other type of computer, such as one or more external computers made available via a cloud computing architecture. The presently described technology is optionally implemented in software devices loaded in memory 408, stored on a configured DVD/CD-ROM 410 or storage unit 412, and/or communicated via a wired or wireless network link 414, thereby transforming the computer system 400 in FIG. 20 to a special purpose machine for implementing the described operations.

The I/O section 404 is connected to one or more user-interface devices (e.g., a keyboard 416 and a display unit 418), a disc storage unit 412, and a disc drive unit 420. In the case of a tablet device, the input may be through a touch screen, voice commands, and/or Bluetooth connected keyboard, among other input mechanisms. Generally, the disc drive unit 420 is a DVD/CD-ROM drive unit capable of reading the DVD/CD-ROM medium 410, which typically contains programs and data 422. Computer program products containing mechanisms to effectuate the systems and methods in accordance with the presently described technology may reside in the memory section 404, on a disc storage unit 412, on the DVD/CD-ROM medium 410 of the computer system 400, or on external storage devices made available via a cloud computing architecture with such computer program products, including one or more database management products, web server products, application server products, and/or other additional software components. Alternatively, a disc drive unit 420 may be replaced or supplemented by an optical drive unit, a flash drive unit, magnetic drive unit, or other storage medium drive unit. Similarly, the disc drive unit 420 may be replaced or supplemented with random access memory (RAM), magnetic memory, optical memory, and/or various other possible forms of semiconductor based memories commonly found in smart phones and tablets.

The network adapter 424 is capable of connecting the computer system 400 to a network via the network link 414, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as terminals, workstations, mobile phones, tablets, laptops, personal computers, multimedia consoles, gaming consoles, set top boxes, and the like.

When used in a LAN-networking environment, the computer system 400 is connected (by wired connection or wirelessly) to a local network through the network interface or adapter 424, which is one type of communications device. When used in a WAN-networking environment, the computer system 400 typically includes a modem, a network adapter, or any other type of communications device for establishing communications over the wide area network. In a networked environment, program modules depicted relative to the computer system 400 or portions thereof, may be stored in a remote memory storage device. It is appreciated that the network connections shown are examples of communications devices for and other means of establishing a communications link between the computers may be used.

In an example implementation, data concerning the operation of the exercise simulators 100, exercise data, health data, the health manager 202, a plurality of internal and external databases (e.g., the database 210), source databases, and/or data cache on cloud servers are stored as the memory 408 or other storage systems, such as the disk storage unit 412 or the DVD/CD-ROM medium 410, and/or other external storage devices made available and accessible via a cloud computing architecture. Exercise simulation and health management software and other modules and services may be embodied by instructions stored on such storage systems and executed by the processor 402.

Some or all of the operations described herein may be performed by the processor 402. Further, local computing systems, remote data sources and/or services, and other associated logic represent firmware, hardware, and/or software configured to control operations of the exercise system 200. Such services may be implemented using a general purpose computer and specialized software (such as a server executing service software), a special purpose computing system and specialized software (such as a mobile device or network appliance executing service software), or other computing configurations. In addition, one or more functionalities of the exercise system 200 disclosed herein may be generated by the processor 402 and a user may interact with a Graphical User Interface (GUI) using one or more user-interface devices (e.g., the keyboard 416, the display unit 418, and the user devices 206) with some of the data in use directly coming from online sources and data stores. The system set forth in FIG. 20 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular examples. Functionality may be separated or combined in blocks differently in various implementations of the disclosure or described with different terminology. These and other variations, modifications, additions, and improvements may fall within the scope of the disclosure as defined in the claims that follow.

What is claimed is:

1. An system for simulating an exercise experience comprising:
a spin assembly rotationally mounted to a handle along an axis line, the spin assembly configured to rotate about the axis line;
at least one weight housed in the spin assembly; and
at least one light source configured to rotate about the axis line with the spin assembly, the at least one light source configured to generate a visual representation of the rotation of the spin assembly.

2. The system of claim 1, wherein the spin assembly is rotationally mounted to the handle using a shaft and a bearing.

3. The system of claim 2, wherein the bearing is a one-way locking needle-roller bearing.

4. The system of claim 1, wherein the handle extends linearly along the axis line.

5. The system of claim 1, wherein the handle extends at an angle relative to the axis line.

6. The system of claim 1, wherein the handle is adjustable relative to the axis line.

7. The system of claim 1, wherein the at least one light source includes a light emitting diode.

8. The system of claim 1, wherein the at least one weight is a solid material.

9. The system of claim 1, wherein the at least one weight is fluid providing counterweight.

10. The system of claim 1, further comprising:
a speaker configured to generate one or more sounds to generate an audio representation of the rotation of the spin assembly.
